(19) United States
(12) Patent Application Publication
(10) Pub. No.: US 2026/0299965 A1
(43) Pub. Date: Oct. 1, 2026

(54) METHOD, APPARATUS, DEVICE, MEDIUM, AND PRODUCT FOR APPLICATION STARTUP

(71) Applicant: Beijing Zitiao Network Technology Co., Ltd., Beijing (CN)

(72) Inventors: Lifeng Cai, Beijing (CN); Jinshan Zhang, Beijing (CN); Zhigang Li, Beijing (CN); Bingtian Han, Beijing (CN)

(21) Appl. No.: 19/340,818

(22) Filed: Sep. 25, 2025

(30) Foreign Application Priority Data
Mar. 26, 2025 (CN) 202510371142.7

(51) Int. Cl. G06F 9/445

(52) U.S. Cl. CPC G06F 9/44505

(57) ABSTRACT

According to embodiments of the disclosure, a method, apparatus, device, medium, and product for application startup are provided. The method includes: determining a plurality of file pages included in at least one file related to startup of an application and respective preloading types of the plurality of file pages; controlling, in response to detecting a first trigger event for the application, loading of the plurality of file pages from a disk to a plurality of linked lists in a memory based on the respective preloading types of the plurality of file pages, where the plurality of linked lists respectively correspond to a plurality of file page reclaiming policies with respective priorities, and each preloading type is mapped to one of the plurality of linked lists; and performing a startup process of the application based on the plurality of file pages stored in the plurality of linked lists in the memory.

### CROSS-REFERENCE

The present application claims priority to Chinese Patent Application No. 202510371142.7, filed on Mar. 26, 2025, and entitled “METHOD, APPARATUS, DEVICE, MEDIUM, AND PRODUCT FOR APPLICATION STARTUP”, the entirety of which is incorporated herein by reference.

### TECHNICAL FIELD

Example embodiments of the disclosure generally relate to the field of computers, and in particular, to a method, apparatus, device, and computer-readable storage medium for application startup.

### BACKGROUND

With the popularization of intelligent terminal devices and the rapid development of mobile Internet, various applications have become important tools for information dissemination, entertainment, and social communication. During the startup process, an application often needs to complete multiple steps such as process creation, resource loading, and interface rendering, which directly affects the user's perception of device performance. To meet the user's requirements for fast startup and smooth experience, terminal manufacturers and application developers need to continuously optimize the response latency and performance of application startup.

### SUMMARY

In a first aspect of the disclosure, a method for application startup is provided. The method includes: determining a plurality of file pages included in at least one file related to startup of an application and respective preloading types of the plurality of file pages; controlling, in response to detecting a first trigger event for the application, loading of the plurality of file pages from a disk to a plurality of linked lists in a memory, respectively, based on the respective preloading types of the plurality of file pages, where the plurality of linked lists respectively correspond to a plurality of file page reclaiming policies with respective priorities, and each preloading type is mapped to one of the plurality of linked lists; and performing a startup process of the application based on the plurality of file pages stored in the plurality of linked lists in the memory.

In a second aspect of the disclosure, an apparatus for application startup is provided. The apparatus includes: a determination module configured to determine a plurality of file pages included in at least one file related to startup of an application and respective preloading types of the plurality of file pages; a loading module configured to control, in response to detecting a first trigger event for the application, loading of the plurality of file pages from a disk to a plurality of linked lists in a memory, respectively, based on the respective preloading types of the plurality of file pages, where the plurality of linked lists respectively correspond to a plurality of file page reclaiming policies with respective priorities, and each preloading type is mapped to one of the plurality of linked lists; and an execution module configured to perform a startup process of the application based on the plurality of file pages stored in the plurality of linked lists in the memory.

In a third aspect of the disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the disclosure, a computer-readable storage medium is provided. The computer-readable storage medium has computer-executable instructions stored thereon, the computer-executable instructions being executable by a processor to perform the method of the first aspect.

In a fifth aspect of the disclosure, a computer-executable instruction product is provided. The computer-executable instruction product is tangibly stored in a computer storage medium and includes computer-executable instructions, the computer-executable instructions, when executed by a device, causing the device to perform the method of the first aspect.

It would be appreciated that content described in this Summary section is neither intended to identify key or essential features of the embodiments of the disclosure, nor is it intended to limit the scope of the disclosure. Other features of the disclosure will be readily envisaged through the following description.

### BRIEF DESCRIPTION OF THE DRAWINGS

The above and other features, advantages and aspects of the embodiments of the disclosure will become more apparent in combination with the drawings and with reference to the following detailed description. In the drawings, the same or similar reference symbols refer to the same or similar elements, where:

FIG. 1A illustrates a schematic diagram of an example environment in which the embodiments of the disclosure may be implemented;

FIG. 1B illustrates a schematic diagram of an example process of application startup;

FIG. 2 illustrates a flowchart of a process for application startup according to some embodiments of the disclosure;

FIG. 3 illustrates a schematic diagram of an architecture of a system for application startup according to some embodiments of the disclosure;

FIG. 4 illustrates a schematic diagram of an example process of acquiring historical startup data according to some embodiments of the disclosure;

FIG. 5 illustrates a schematic diagram of an example process of application startup according to some embodiments of the disclosure;

FIG. 6 illustrates a schematic structural block diagram of an apparatus for application startup according to some embodiments of the disclosure; and

FIG. 7 illustrates a block diagram of an electronic device in which one or more embodiments of the disclosure may be implemented.

### DETAILED DESCRIPTION OF EMBODIMENTS

The embodiments of the disclosure will be described in more detail below with reference to the drawings. Although some embodiments of the disclosure are shown in the drawings, it would be appreciated that the disclosure may be implemented in various forms, and should not be interpreted as limited to the embodiments set forth herein. On the contrary, these embodiments are provided for a more thorough and complete understanding of the disclosure. It would be appreciated that the drawings and embodiments of the disclosure are only for illustrative purposes, and are not intended to limit the protection scope of the disclosure.

In the description of the embodiments of the disclosure, the term “include/comprise” and similar terms thereto should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other definitions, either explicit or implicit, may also be included below.

Herein, unless explicitly stated, the step performed “in response to A” does not mean that the step is performed immediately after “A”, but may include one or more intermediate steps.

It would be appreciated that the data involved in the technical solution (including but not limited to the data itself, acquisition or use of the data) should comply with requirements of corresponding laws, regulations, and related provisions.

It would be appreciated that before the use of the technical solution disclosed in the embodiments of the disclosure, the user should be informed of the type, scope of use, usage scenarios, etc., of personal information involved in the disclosure and the authorization of the user should be obtained in an appropriate manner in accordance with relevant laws and regulations.

For example, in response to reception of an active request from a user, prompt information is sent to the user to clearly inform the user that the requested operation will require access to and use of the user's personal information, so that the user may independently choose, based on the prompt information, whether to provide the personal information to software or hardware, such as an electronic device, an application, a server, or a storage medium, that performs the operations of the technical solution of the disclosure.

As an optional but non-restrictive implementation, in response to the reception of the active request from the user, the prompt information may be sent to the user in the form of, for example, a pop-up window, in which the prompt information may be presented in text. Furthermore, the pop-up window may also include a select control for the user to choose whether to “agree” or “disagree” to provide the personal information to the electronic device.

It would be appreciated that the above process of notifying and obtaining user authorization is only illustrative, and does not constitute a limitation on the implementations of the disclosure. Other manners that satisfy the relevant laws and regulations may also be applied in the implementations of the disclosure.

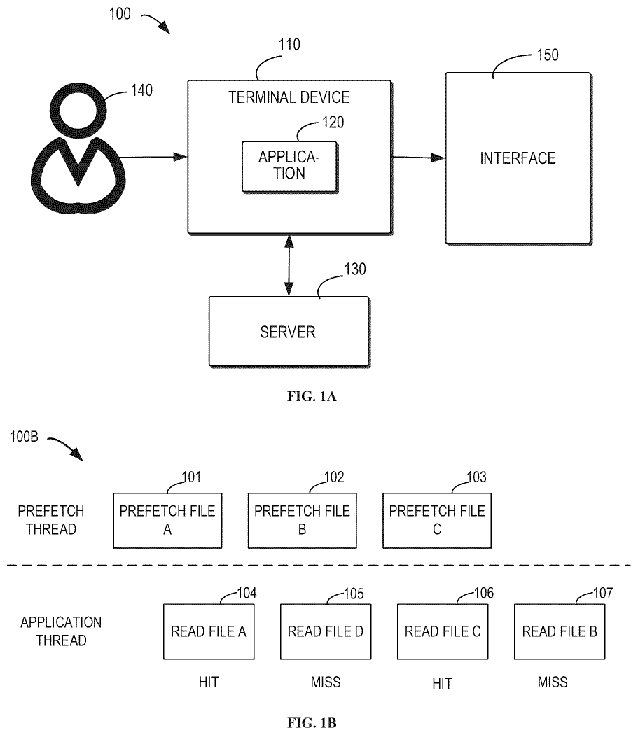

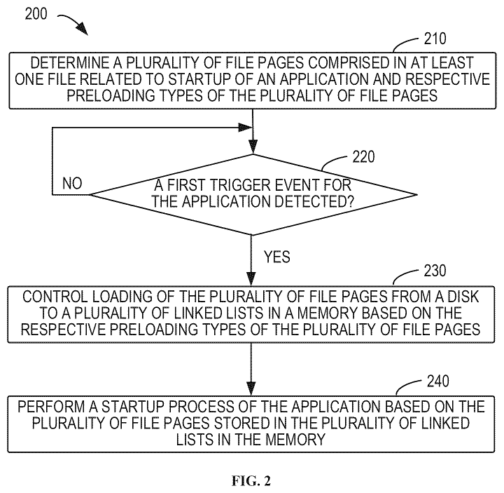

FIG. 1A shows a schematic diagram of an example environment 100 in which the embodiments of the disclosure may be implemented. In this example environment 100, an application 120 is installed on a terminal device 110. A user 140 may interact with the application 120 via the terminal device 110 and/or a device attached to the terminal device 110. The application 120 may be a content presentation application (e.g., a video playback application), an online shopping application, or any other suitable application.

In the environment 100 of FIG. 1A, if the application 120 is in an active state, the terminal device 110 may present an interface 150 of the application 120. The interface 150 may include various types of user interfaces that may be provided by the application 120, such as a content presentation interface, a content creation interface, a content publishing interface, a message interface, a personal homepage, and so forth. The application 120 may provide a content viewing function to view various types of content published in the application 120. Via corresponding pages, the application 120 may provide various types of online content to the user 140. The embodiments of the disclosure are not intended to limit the specific functions of the application and the presented content. Via an appropriate triggering manner, such as clicking or selecting an application icon, the running of the application may be activated.

In some embodiments, the terminal device 110 communicates with a server 130 to implement the provision of services of the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including the fittings and peripherals of these devices or any combination thereof. In some embodiments, the terminal device 110 may also support any type of user-specific interface (such as “wearable” circuitry, etc.). The server 130 may be various types of computing systems/servers that may provide computing power, including but not limited to mainframes, edge computing nodes, computing devices in cloud environments, and so forth.

It would be appreciated that the structures and functions of the elements in the environment 100 are described for illustrative purposes only, without suggesting any limitation to the scope of the disclosure.

As briefly mentioned above, with the popularization of intelligent terminal devices and the rapid development of mobile Internet, users'requirements for application startup speed and operation smoothness are becoming increasingly higher. Application startup performance has also become an important indicator for measuring user experience. Application startup latency is an important factor in measuring application startup performance and affecting user experience, which refers to the time interval from a user triggering a launch action (e.g., clicking application icon on the desktop, clicking a notification, or launching an application from another entry) to the content of the application interface being successfully loaded and displayed on the screen of the terminal device. The startup of an application may be divided into cold start and hot start.

Cold start is an important scenario of application startup, which refers to the process of restarting an application when it has been completely exited (the process does not exist). During the cold start process, multiple steps such as application process creation, application resource loading, activity creation, and interface rendering need to be completed, and this process directly affects the user's perception of device performance. To meet the users'requirements for fast launching and smooth experience, terminal manufacturers and application developers need to continuously optimize the response latency of cold start. Hot start refers to the case where the application is already running in the background and the user opens the application again, the application still resides in the memory, and thus the application may be quickly started and the application interface may be presented to the user.

During the cold start process of an application, a large number of application resources usually need to be loaded from a disk, for example, a main package file of the application, runtime environment files, and other resource files, configuration files, etc. Since the speed at which a processor loads data from a disk is relatively slow, this process affects the speed and performance of application cold start to a great extent. In contrast, the speed at which the processor reads data from a memory is much faster. Therefore, preloading (also referred to as prefetching) solutions, which load into the memory in advance files required during the application startup process, has become a feasible optimization direction for accelerating the application startup process. However, the traditional application preloading solutions still have certain problems. Several typical scenarios are described below.

One scenario involves the issue of data accuracy. Specifically, the preloading solution mainly relies on collecting file data that fails to hit the cache during the cold start process, or sampling virtual memory snapshots of the application. This approach may reduce, to a certain extent, the number of times files are read from the disk, but when the application or user environment changes, the collected data may become invalid. For example, application updates or changes in the content of configuration files and resource files may cause the pre-collected data to be inconsistent with the actual cold start requirements.

Another scenario involves the balance between data volume and performance. Specifically, if too many files are prefetched at one time, the input/output (I/O) bandwidth of the device will be occupied, resulting in the blocking of I/O operations of the application's main thread, thus affecting the actual cold start performance of the application. If the prefetch thread has a lower priority and reads at a slower speed, causing the data not to be loaded into the memory in time and the main thread failing to hit the prefetched data (e.g., when the file has not been fully loaded and the first frame rendering has already started), the cold start latency cannot be effectively reduced.

Another scenario involves the issue of prefetch accuracy. Specifically, traditional cold start prefetch solutions usually insert the prefetched file pages directly into the tail of the inactive page linked list in the memory, for example, the tail of the inactive least recently used (LRU) linked list. If the prefetched file pages are not used, the system will preferentially reclaim these file pages when the memory is under pressure.

As an example, FIG. 1B shows a schematic diagram of an example process 100B of application startup. As shown in FIG. 1B, during the application cold start, the prefetch thread executes blocks 101-103 to load (prefetch) files A, B, and C into the inactive LRU linked list in the memory according to a preset order. These files have not been actually used by the application main thread at this point, so their state is “inactive”. In addition, during the process of application cold start, the application thread may not read the files completely according to the prefetch order, but instead loads them on demand according to the operation logic.

Referring to FIG. 1B, at block 104, the application thread first reads file A, which hits the inactive LRU linked list in the memory. At this point, file A is moved to the active page linked list in the memory, for example, the active LRU linked list, and the state becomes “active”. At block 105, because the prefetch thread has not pre-loaded file D, a miss occurs, and file D needs to be read from the disk. At block 106, the application thread reads file C, which hits the inactive LRU linked list in the memory. At block 107, the application thread reads file B. Since file B was loaded into the inactive LRU linked list in the memory, file B will be preferentially reclaimed from the inactive LRU linked list to the disk when the memory is under pressure. Therefore, file B needs to be loaded from the disk again. This secondary loading operation brings additional disk I/O operations, which may directly lead to performance degradation of the application main thread and may cause possible frame dropping and stuttering.

In view of this, according to the embodiments of the disclosure, an improved solution for application startup is proposed. The solution includes: first, determining a plurality of file pages included in at least one file related to startup of an application and respective preloading types of the plurality of file pages; if a first trigger event for the application is detected, controlling the loading of the plurality of file pages from a disk to a plurality of linked lists in a memory based on the respective preloading types of the plurality of file pages, where the plurality of linked lists respectively correspond to a plurality of file page reclaiming policies with respective priorities, and each preloading type is mapped to one of the plurality of linked lists; and then, performing a startup process of the application based on the plurality of file pages stored in the plurality of linked lists in the memory.

Thus, by loading the plurality of file pages from the disk to the plurality of linked lists in the memory that correspond to the plurality of file page reclaiming policies with respective priorities based on preloading types, respectively, file pages with a higher loading probability of subsequent loading may be preferentially retained when the memory is under pressure. In this way, it is possible to avoid the situation where more important file pages need to be loaded from the disk again after being swapped out of memory during the cold start process. By this approach, the time required for the application cold start may be reduced, and the smoothness of application startup may be improved, thereby providing users with a better operation experience.

Some example embodiments of the disclosure will be further described below with reference to the accompanying drawings. Furthermore, in the following, the example embodiments will be mainly described with respect to the terminal device 110. It would be appreciated that the actions described with respect to the terminal device 110 may be performed by the application 120 on the terminal device 110, or may be performed by the application 120 in cooperation with its server (e.g., the server 130).

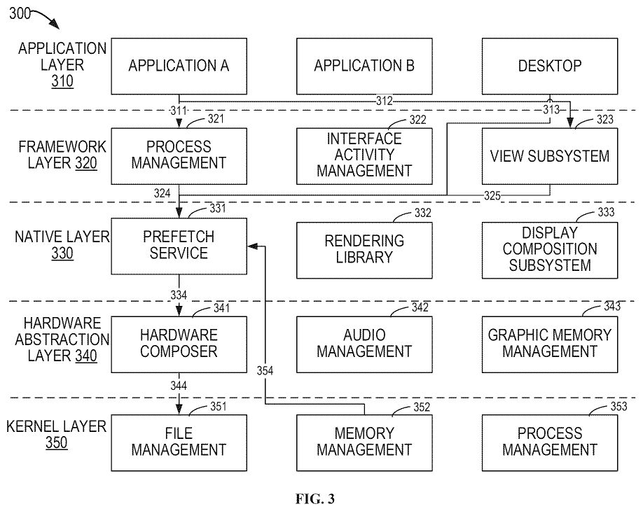

FIG. 2 shows a flowchart of a process 200 of application startup according to some embodiments of the disclosure. The process 200 may be implemented at the terminal device 110. The process 200 is described below with reference to FIG. 1A.

At block 210, the terminal device 110 determines a plurality of file pages included in at least one file related to the startup of the application 120 and respective preloading types of the plurality of file pages. Generally, when starting an application, especially in a cold start, a plurality of file pages included in the related file need to be read from a storage device for rendering the interface of the application. A file page or a “page” of a file is a basic data unit for an operating system to manage the memory and disk data.

During the application startup process 120, the process of loading file pages from the disk into the memory due to cache misses is often an important factor limiting the performance of application startup. A cache miss refers to the situation where, when accessing a page of a file, the file page is not stored (hit) in the cache in the memory, and the file page needs to be loaded from the disk into the memory. Therefore, the terminal device 110 may determine relevant information of the plurality of file pages included in the at least one related file that needs to be read when the application 120 is started. In this way, it may be discovered which file pages are frequently read or frequently experience cache misses during the application startup process. This information may help preload these file pages related to the startup of the application 120 in the subsequent application startup process, reducing runtime disk I/O operations, thereby shortening the cold start time.

Since multiple types of file data need to be loaded during the application startup process, in the embodiments of the disclosure, the terminal device 110 may classify the plurality of file pages based on the file importance and access patterns during historical startup processes. In other words, the terminal device 110 may determine the respective preloading types of the plurality of file pages related to the startup of the application. The preloading type is used to guide application startup, especially the preloading strategy corresponding to the file pages during the during the application cold start process. This classification helps optimize prefetch efficiency and memory utilization, thereby reducing cold start latency and improving application performance.

In some embodiments, the terminal device 110 may determine the respective preloading types of the plurality of file pages based on at least one of a file type corresponding to each file page and historical startup data of the application. The file type indicates the nature or usage of the file to which the file page belongs. The historical startup data may include the file page access acquired and recorded during several startups of the application 120 after being installed on the terminal device 110. The terminal device 110 may retain the startup data of the application 120 for a certain number of times within a past period of time (for example, the most recent N times, where N may be a preset value) as the historical startup data for determining the respective preloading types of the plurality of file pages related to the startup of the application 120. Alternatively or additionally, the terminal device 110 may further re-collect the application startup data for several times after each device boot or based on a predetermined time period as the historical startup data for determining the preloading type of the file page.

As an example, the terminal device 110 may use a sliding window mechanism to acquire historical startup data corresponding to the plurality of file pages loaded from the application cold start 120 to the first frame rendering the application 120 during the first several startups after the application 120 is installed. Here, the first frame refers to the user interface that the application 120 renders and presents for the first time after the startup is completed. Alternatively or additionally, the terminal device 110 may also use a kernel-level instrumentation function to directly locate the loading behavior of the file page to obtain more accurate historical startup data.

In some embodiments, the historical startup data at least indicates a number of cache misses of each file page during a historical startup. The number of cache misses refers to the number of cache misses of the file page in the historical startup (that is, the number of times the file page fails to hit the memory cache and needs to be loaded from the disk). The higher the number of cache misses, the higher the loading frequency of the file page during the application startup, and the more the file page should be preferentially considered to be preloaded into the memory.

In some embodiments, the historical startup data further indicates a timestamp when each of the plurality of file pages is read or a number of times loaded into the memory during the startup. Alternatively or additionally, the historical startup data further indicates at least one of a file name, a file identification, an offset in a file, or a length of each file page.

The timestamp when the file page is read during the startup refers to a specific time point, represented by the timestamp, at which the file page is read during the application startup process (especially during the cold start process). It provides the time sequence information of the file page loading, which is used to analyze the order and frequency of the file page loading.

The number of times a file page is loaded into the memory may also be understood as the access frequency of the file page. Each time the application reads a file page, the terminal device 110 may count the number of times the file page is accessed. By counting the access frequency of each file page, it may be determined which file pages are “hot file pages” (i.e., files that are frequently accessed).

The file name and the file identification record the name and unique identification of the file to which the file page belongs, for quickly locating the source of the file page. The offset and the length in the file indicate the specific location (offset) and size (length) of the file page within the file, which are used to determine the specific file page content and optimize the location accuracy during prefetching.

In some embodiments, the historical startup data is stored in association with an application identification of the application and a user identification of a user who launches the application. The application identification includes, for example, a package name of the application, and is used to identify the specific application corresponding to the startup data. The user identification includes, for example, a user identifier (UID), which is used to identify the specific user who launches the application. By associating historical startup data with the package name and UID, targeted optimization strategies may be provided for different users and different applications, thereby further optimizing the user experience.

In some embodiments, the historical startup data may include only relevant startup data of the file page upon cache misses, but also the complete startup data of the plurality of file pages loaded by the application. Specifically, the specific startup data to be acquired may be selected according to the business scenario, which is not limited in the disclosure.

In the embodiments of the disclosure, by collecting the historical startup data of file pages and retaining the records of the first several startups, the preloading strategy of file pages may be dynamically optimized, and important file pages in the cold start may be accurately identified. In addition, this method may adapt to the dynamic changes of the application scenarios and user behaviors, thereby improving the accuracy of the preloaded data. In some embodiments, as the historical startup data and the file types required for the application startup change, the data of respective file pages may also be dynamically updated.

After acquiring the file type corresponding to the file page and historical startup data, the preloading type of each file page may be determined accordingly.

In some embodiments, the file type may include an application data type or a configuration file type, for example, a database file, an extensible markup language (XML) file related to the application configuration, and the like. These files generally store data required for the business logic of the application or configuration information of the application. And the content of these files may change frequently due to factors such as user operation, application update or data synchronization.

By way of example, the terminal device 110 may determine that the preloading type of the first file page is the first preloading type based on the file type corresponding to the first file page among the plurality of file pages being the application data type or the configuration file type. The content of file pages of the application data type or the configuration file type may change frequently due to user behavior or dynamic adjustment of the application. Therefore, preloading the file page of this type into the memory may still require reloading from the disk due to data changes or file inflation, resulting relatively low prefetch accuracy. Therefore, the terminal device 110 may determine the preloading type of the first file page as the first preloading type. As will be further discussed below, file pages belonging to the first preloading type, when preloaded from disk into memory, will be stored into a first linked list having a first priority file page reclaiming policy. In this way, file pages of this type may be preferentially reclaimed when the memory is under pressure.

In some embodiments, the file type may also include an executable file type, for example, a Java archive (Jar) file, a Dalvik executable (Dex) file, a shared library (So) file, a binary (Bin) file, and the like related to the application execution. These files are executable files directly used during the program runtime, and determine the functional implementation of the application or system. Moreover, these files may be loaded or used multiple times during application runtime, with high usage certainty.

By way of example, the terminal device 110 may that the preloading type of the second file page is the second preloading type based on the preloading type of the second file page among the plurality of file pages being the executable file type. File pages of the executable file type are usually the core resources for the application startup and subsequent logic, and are accessed more frequently. Even if these file pages may not hit during the cold start, they will still be frequently executed during the subsequent application runtime. Therefore, the terminal device 110 may determine the preloading type of the second file page as the second preloading type. As will be further discussed below, file pages belonging to the second preloading type, when preloaded from disk into memory, will be stored in a second linked list having a second priority file page reclaiming policy, the second priority being lower than the first priority. In this way, file pages of this type are given a higher memory residency priority than file pages of the first preloading type. When the memory is under pressure, this type of file page will not be easily reclaimed.

In some embodiments, the file type may also include a system file type, for example, an XML file, a Jar file, a Dex file, a So file, a Bin file, and the like related to the system framework. These files are core files provided at the system, supporting the operation of the entire system. System files generally do not change as frequently as application data files and configuration files, and have higher usage certainty.

By way of example, the terminal device 110 may determine that the preloading type of the third file page is the third preloading type based on the file type of the third file page among the plurality of file pages being the third file page of the system file type. The content of system files is usually fixed and suitable for long-term residency in the memory and avoids repeated loading. Therefore, the terminal device 110 may determine the preloading type of the third file page as the third preloading type. As will be further discussed below, file pages belonging to the third preloading type, when preloaded from disk into memory, will be stored in a third linked list having a third priority file page reclaiming policy, the third priority being lower than the second priority. In this way, file pages of this type are given a higher memory residency priority than file pages of the second preloading type. Even when the memory is under pressure, this type of file pages are still preferentially retained, and may only be reclaimed back to the disk in extreme cases.

In some embodiments, as mentioned above, the historical startup data may also be considered when determining the preloading type of the file page, especially cache miss situations during the historical startup,. In some embodiments, the terminal device 110 determines that the preloading type of the first file page is the first preloading type based on the number of cache misses of the first file page being less than or equal to a first threshold number. In other words, if the number of cache misses of the first file page is less than or equal to the first threshold number (such as a relative low number), it indicates that the file page is accessed relatively infrequent during the application startup process (especially the cold start process). Therefore, the terminal device 110 may determine the preloading type of the first file page as the first preloading type. In this way, file pages of this type may be preferentially reclaimed when the memory is under pressure. Note that in this disclosure, each threshold may be configured according to a specific application, and the embodiments of the disclosure do not limit the threshold configuration.

As another example, the terminal device 110 determines that the preloading type of the second file page is the second preloading type based on the number of cache misses of the second file page being less than or equal to a second threshold number, where the second threshold number is greater than the first threshold number. If the number of misses of the second file page is less than or equal to the second threshold number (such as a medium number), it indicates that the file page is relatively used more frequently in the cold start, but its importance may not be the highest. Therefore, the terminal device 110 may determine the preloading type of the second file page as the second preloading type. In this way, file pages of this type are given a higher memory residency priority than file pages of the first preloading type.

In some embodiments, the terminal device 110 may determine that the preloading type of the first file page is the second preloading type based on the file type corresponding to the first file page being the application data type or the configuration file type, but the number of cache misses of the first file page being greater than the first threshold number.

File pages of the application data or the configuration file type are usually determined as the first preloading type. The content of these files changes relatively frequently, and the historical startup data may be inaccurate, therefore, they may be preferentially reclaimed when the memory is under pressure. However, if the number of cache misses of a certain application data or configuration file page is greater than the first threshold number (for example, multiple cache misses occur) , it indicates that the file page is frequently accessed during the cold start process, and is of higher importance than ordinary application data files or configuration files. Therefore, the terminal device 110 may upgrade its preloading type to the second preloading type, thereby lowering its priority of being reclaimed from the memory.

In some embodiments, the terminal device 110 may determine that the preloading type of the second file page is the third preloading type based on the preloading type of the second file page being the executable file type, but the number of cache misses of the second file page being greater than the second threshold number.

File pages of the executable file type are usually determined as the second preloading type. During the cold start and subsequent application runtime, these file pages may be read multiple times. If the number of cache misses of a file page of a certain executable file type is greater than the second threshold (for example, cache misses occur frequently), it indicates that the file page is frequently accessed during the cold start and subsequent application runtime, which may be one of the performance bottlenecks of the application cold start. Therefore, the terminal device 110 may further upgrade its preloading type to the third preloading type, thereby further lowering its priority of being reclaimed from the memory.

In the embodiments of the disclosure, the preloading type is dynamically determined based on factors such as the importance of the file page to the application startup, the number of cache misses, the access frequency and the like. In this way, corresponding preloading operations may be performed according to the preloading type of the file page, thereby reducing the redundancy of preloaded data and increasing the hit rate of preloaded file pages. In this way, not only is the overhead of disk I/O operations during the application cold start is reduced, but also the efficiency of memory utilization and resource allocation is optimized.

In some embodiments, the process of determining and recording the respective preloading types of the plurality of file pages related to the startup of the application may be performed before the application cold start is triggered.

Returning to FIG. 2, at block 220, the terminal device 110 determines whether a first trigger event for the application is detected. If the first trigger event is detected, the terminal device 110 may perform block 230. At block 230, the terminal device 110 controls the loading of the plurality of file pages from the disk to the plurality of linked lists in the memory based on the respective preloading types of the plurality of file pages.

In some embodiments, the plurality of linked lists in the memory may include the first linked list, the second linked list, and the third linked list mentioned above. In a memory management mode, various linked list structures may be included to organize and manage file pages loaded into the memory. For example, the linked lists in the memory may include the LRU linked list. An LRU linked list is a commonly used page replacement algorithm. In an LRU linked list, the processor selects the least recently used page (for example, a file page) for elimination, that is, deletion from the memory. In this way, if the file page needs to be read during the actual startup, it will need to be read from the disk again. In addition, each of the first linked list, the second linked list, and the third linked list may represent a different priority category, which determines the residence time in the memory and the reclaiming order of the file pages loaded into the linked list.

In some embodiments, the plurality of linked lists in the memory respectively correspond to a plurality of file page reclaiming policies with respective priorities, and each preloading type is mapped to one of the plurality of linked lists. By way of example, the terminal device 110 may control the loading of the plurality of file pages from the disk to the plurality of linked lists in the memory according to a predetermined mapping relationship between the preloading type of the file page and the plurality of linked lists.

The first preloading type is mapped to the first linked list of the plurality of linked lists. The terminal device 110 may load the first file page into the first linked list of the plurality of linked lists in response to the preloading type of the first file page among the plurality of file pages being the first preloading type.

The first linked list has a first priority file page reclaiming policy. For example, the first linked list may be an inactive LRU linked list, which is used to store file pages with lower importance or higher uncertainty during the application startup process. Loading the file page of the first preloading type into the first linked list may ensure that when the memory is under pressure, file pages in the first linked list may be preferentially reclaimed back to the disk, thereby improving the preloading accuracy and the utilization rate of memory resources.

The second preloading type is mapped to the second linked list of the plurality of linked lists. The terminal device 110 may load the second file page into the second linked list of the plurality of linked lists in response to the preloading type of the second file page among the plurality of file pages being the second preloading type.

The second linked list has a second priority file page reclaiming policy, where the second priority is lower than the first priority. For example, the second linked list may be an active LRU linked list, which is used to store file pages with a higher access frequency or probability during the application startup process or the subsequent application runtime. When the memory is under pressure, file pages in the second linked list may be reclaimed back to the disk later than file pages in the first linked list. In this way, the memory residency rate of high-frequency access file pages may be improved, thereby reducing the swapping out of file pages and performance loss of the disk I/O operations.

The third preloading type is mapped to the third linked list of the plurality of linked lists. The terminal device 110 loads the third file page into the third linked list of the plurality of linked lists in response to the preloading type of the third file page among the plurality of file pages being the third preloading type.

The third linked list has a third priority file page reclaiming policy, where the third priority is lower than the second priority. For example, the third linked list may be a protect LRU linked list, which is used to store core file pages that significantly affect the startup performance during the application startup process. When the memory is under pressure, file pages in the third linked list may be reclaimed back to the disk later than file pages in the second linked list. In this way, it may be ensured with high probability that the core file pages remain resident in the memory, thereby avoiding performance degradation caused by being swapped out of the memory.

In some embodiments, the terminal device 110 may load the plurality of file pages into the plurality of linked lists based on an order of timestamps at which the plurality of file pages are read during historical startups. During historical application startups, the time point at which each file page is read is accurately recorded in the form of a timestamp. Therefore, the terminal device 110 may preload the file pages into the memory according to the timestamps, that is, the reading order during the startup process. In this way, the file pages preloaded into the memory may better match the actual reading order during the application startup process, thereby improving the accuracy of the preloaded files and making the application startup process more efficient and precise.

In some embodiments, in response to the preloading type of a fourth file page among the plurality of file pages being the third preloading type, and the number of cache misses of the fourth file page being greater than a third threshold number, the terminal device 110 may lock the fourth file page in the memory using a memory locking mechanism.

As an example, if the number of cache misses of a file page exceeds a configured third threshold (that is, cache misses occur frequently during historical startups), it indicates that the file page requires frequent disk I/O operations during the application startup process, which seriously affects the startup performance of the application. The terminal device 110 may lock the fourth file page into the physical memory using a memory locking mechanism (such as the locking mechanism mlock). Pages locked into the memory with mlock will not be swapped out to the disk. This mechanism may ensure that important file pages always reside in the memory, even when the memory resources are under pressure.

In the embodiments of the disclosure, by performing the memory locking operation on the high-priority file pages with multiple cache misses, important pages may be accurately identified and protected, while adapting to the dynamic changing scenario requirements. In this way, the efficiency of application startup is effectively improved, and the long-term performance and user experience of the application are also enhanced.

In some embodiments, the first trigger event may be understood as a signal for performing the preloading operation. For example, the terminal device 110 determines that the first trigger event is detected in response to determining a press event for the application based on a detected touch operation. The touch operation may be, for example, a touch-and-press operation (represented as a touch_down operation) of the user clicking on the application icon.

Traditionally, the process of preloading file pages is usually triggered after the user lifts the finger, for example, after detecting and determining a click event (represented as an onClick event). Therefore, only after both the touch_down operation and the touch release operation (represented as touch_up) operation are detected and determined to constitute a click operation, and the corresponding preloading process will be started. However, there is usually a time interval of several tens of milliseconds between the touch_down (touch-and-press) operation and the touch_up (touch-and-release) operation. This time interval may be further used to preload file pages into the memory in advance to further reduce the startup latency.

For example, once the terminal device 110 determines the press event for the target application based on the detected touch_down operation of the user, the process of loading the plurality of file pages related to the application startup into the memory may be started. In this way, the user's intention to start the application may be perceived in advance, making the full use of the time gap of the user's operation to pre-load important file pages into the memory. In this way, the cold start process of the application becomes smoother, and the startup time perceived by the user is reduced.

Returning to FIG. 2, at block 240, the terminal device 110 performs the application startup process based on the plurality of file pages stored in the plurality of linked lists in the memory.

In the embodiments of the disclosure, during the application startup process, the terminal device 110 may first access the required file pages from the plurality of linked lists, directly reading from the memory, thereby greatly reducing disk I/O operations. In addition, by storing the low-priority file pages in the first linked list, they may be preferentially reclaimed when the memory is under pressure, freeing resources for more important tasks. By retaining higher-priority file pages in the second linked list or the third linked list, the hit rate of the important pre-loaded files can be improved, avoiding cache misses that would otherwise reduce the application startup speed.

As an example, FIG. 3 shows a schematic diagram of the architecture of a system 300 for application startup according to some embodiments of the disclosure. The system 300 may be implemented at the terminal device 110.

Referring to FIG. 3, the system 300 includes an application layer 310. The application layer 310 includes a specific application 120 installed on the terminal device 110 for interacting with the user, such as application A, application B, and the like shown in FIG. 3, and a desktop where the application 120 resides. The embodiments of the disclosure do not limit the specific type of the application.

Continuing with reference to FIG. 3, the following description takes the cold start process of application A as an example to illustrate the roles of various modules included in system 300. In response to detecting a click event for application A, the system 300 passes (311-313) the signal of the event to the framework layer 320 and the native layer 330 for processing.

The framework layer 320 is mainly responsible for application process management and interface lifecycle control. At the framework layer 320, in response to detecting the launch request for application A, the process management module 321 is used to create a process corresponding to application A and initialize resources.

The process management module 321 is used to create and manage the process of the application, as well as identify application processes that need to be started and initialize related resources, to start the cold start process. During the startup process, the process management module 321 may pass (324) resource requirements (such as an executable file, etc.) associated with the started application process to the prefetch service 331 of the native layer 330. After the process is started, the interface activity management module 322 is responsible for notifying the application to complete the initialization and enter the running state. Activity is a basic interface unit of the application and is responsible for processing the logic of the application interface display.

After the activity initialization is completed, the view subsystem 323 is responsible for controlling the first frame rendering of the interface of application A. During the first frame rendering process, the view subsystem 323 may identify required resources (such as layout files, image resources, and the like), and pass (325) the loading requirements of these resources to the prefetch service 331.

The native layer 330 mainly processes underlying resource loading and graphics rendering. At the native layer 330, the prefetch service 331 is started in response to detecting a click event for application A. The prefetch service 331 works closely with file management and memory management modules in the operating system. The prefetch service 331 is responsible for controlling the preloading of file pages related to the application startup into the memory to reduce the disk I/O operation time, thereby accelerating application cold start speed. The prefetch service 331 may notify (334) the hardware composer 341 of the hardware abstraction layer (HAL) 340 to perform the file page prefetch operation according to the first frame rendering resource requirements and process-related resource information acquired from the framework layer 320.

The native layer 330 further includes a rendering library 332 (Rendering Library), which is responsible for performing graphics rendering of the application UI. The native layer 330 further includes a display composition subsystem 333 for composing multiple layers (such as application interfaces and system interfaces) and displaying them on the screen.

The hardware abstraction layer 340 connects system software and hardware and provides abstract access to hardware resources. The hardware composer 341 is responsible for coordinating hardware resources to optimize graphics composition and display. After receiving the notification of the execution of the file page prefetch operation from the prefetch service 331, the hardware composer 341 issues (344) a file page prefetch request to the file management module 351 and the memory management module 352 of the kernel layer 350.

The hardware abstraction layer 340 further includes an audio management module 342 for implementing a bridge function between the audio hardware and upper-layer software and manages audio resources. The hardware abstraction layer 340 further includes a graphic memory management module 343 (Graphic Allocator) for allocating and managing graphic memory.

The kernel layer 350 is responsible for the bottom-level resource management of the system. The file management module 351 is responsible for loading file pages required for startup from a storage device (such as a disk or a flash memory). The memory management module 352 is used for the control and management of memory-related operations. For example, at the kernel layer 350, a plurality of file pages related to the startup of application A are preloaded into a plurality of linked lists (an inactive LRU linked list, an active LRU linked list, and a protect LRU linked list) in the memory based on the preloading type of the file page. In addition, the prefetch service 331 may further collect (354) cache information of file pages by interacting with the memory management module 352 in order to monitor the loading state of file pages and ensure the integrity and timeliness of resource loading.

The kernel layer 350 further includes a process management module 353, which is responsible for scheduling and managing process execution at the operating system level to ensure the reasonable allocation of operating system resources.

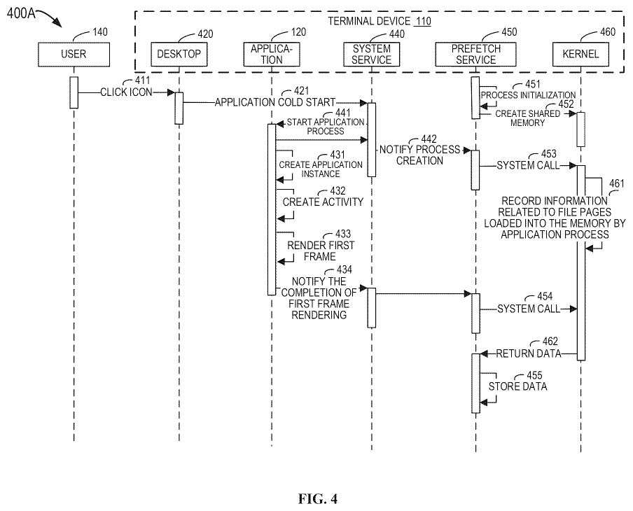

As an example, FIG. 4 shows a schematic diagram of an example process 400A of acquiring historical startup data according to some embodiments of the disclosure. As shown in FIG. 4, the process 400A of acquiring historical startup data involves a user 140 interacting with the application, a desktop 420 of the application 120 interacting with the user 140, a system service 440 (System Server) for managing system resources and providing system functions, a prefetch service 450 (Prefetch Service Process) responsible for preloading file pages related to the application startup, and a kernel 460 for handling system call operations (such as memory and disk operations). Among these, 420-460 are included in the terminal device 110, and the application 120 is installed on the terminal device 110.

In the process 400A, the user 140 first clicks (411) the application icon of the application 120 on the desktop 420 to trigger the application startup process 120. The desktop 420 sends (421) a request for application cold start to the system service 440. The system service 440 starts (441) the corresponding process of the application 120. In the corresponding process of the application 120, an application instance is created (431) to initialize various data required by the application 120. Then, an activity is created (432) and the rendering (433) of the first frame of the application 120 is started.

In some embodiments, the prefetch service 450 is initialized (451) during cold start, and creates (452) a shared memory for passing data related to file pages (such as historical startup data) with the kernel 460. Then, the prefetch service 450 notifies (453) the kernel 460 via a system call to start collecting historical startup data.

The kernel 460 records (461) information related to file pages loaded into the memory by application threads through a kernel-level hook method, for example, including: file name, file identification (inode), file page offset, file page length, file type, etc.

After the first frame rendering of the application 120 is completed, the application 120 notifies (434) the system service 440, indicating that the cold start process of the application 120 ends. The system service 440 notifies the prefetch service 450. The prefetch service 450 notifies (454) the kernel 460 via a system call to end the collection of the startup data for this cold start process, for example, file page reading information during the cold start process.

The kernel 460 returns (462) the collected file page reading information to the prefetch service 450 through the shared memory. The prefetch service 450 stores (455) this information into a specified file for subsequent analysis or prefetch policy optimization.

In some embodiments, the terminal device 110 may use a sliding window mechanism to perform the aforementioned process 400A of acquiring historical startup data in the first several startups after the application is installed, thereby providing important information support for optimizing the application startup performance and improving resource utilization.

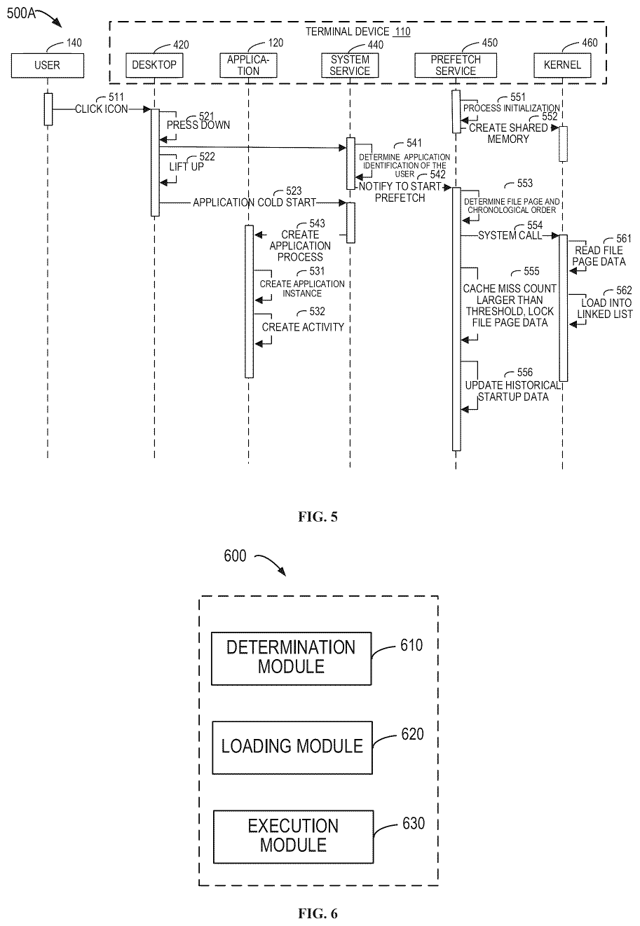

As another example, FIG. 5 shows a schematic diagram of an example process 500A of application startup according to some embodiments of the disclosure. As shown in FIG. 5, the process 500A of application startup involves the same or similar execution entities or modules as the process 400A.

In the process 500A, the user 140 first clicks (511) the application icon on the desktop 420 to trigger the application startup process. In response to detecting (521) an event of the user 140 pressing (touch_down) the icon of the application 120, the desktop 420 notifies the system service 440 to trigger the prefetch logic. The prefetch service process 450 is initialized (551) during the application cold start, and creates (552) a shared memory for passing data related to file pages (such as historical startup data) with the kernel 460.

The system service 440 identifies (541) the UID and package name of the clicked application, and locates the target application that needs to be started. Then, the system service 440 notifies (542) the prefetch service 450 to execute the prefetch logic.

The prefetch service 450 determines (553), based on the historical startup data, the file pages required by the target application and the time sequence usage records of each file page, and processes them in chronological order. Then, the prefetch service 450 controls (561) the kernel 460 via a system call to read the file page data from the disk. After reading the file page data from the disk, the kernel 460 loads (562) the file page data into the corresponding linked list based on the preloading types of the file pages, for example, inserts the file page data into the tail of the active LRU linked list, the inactive LRU linked list, or the protect LRU linked list, respectively.

During the file prefetch process, if the desktop 420 detects (522) that the user 140 releases the finger (touch_up), it notifies (523) the system service 440 to execute the logic of application cold start. The system service 440 creates (543) the corresponding process of the application 120. Then, in the corresponding process of the application 120, an application instance is created (531) based on the file pages preloaded into the memory, for example, by executing an instantiation method to initialize various data required by the application. Subsequently, an activity corresponding to the application 120 is created (532).

In some implementations, the prefetch service 450 may identify (555) whether there is a file page of the system file type having a number of cache misses greater than a predetermined threshold number. If yes, after reading these file pages into the memory, the prefetch service 450 locks these file pages in the memory using the mlock locking mechanism to avoid being reclaimed by the memory reclaiming mechanism. The prefetch service 450 may also update (556) the historical startup data, thereby continuously monitoring the state and information related to application access to the file pages.

In summary, according to various embodiments of the disclosure, based on preloading types, the plurality of file pages are loaded from the disk to the plurality of linked lists in the memory that correspond to the plurality of file page reclaiming policies with respective priorities, respectively. In this way, important file pages may be preferentially retained when the memory is under, thereby avoiding the situation that important file pages need to be loaded from the disk again after being swapped out of the memory during the cold start process. In this way, the time required for the application cold start may be reduced, and the startup smoothness of the application may be improved, thereby providing the user with a better operation experience.

### Example Apparatus and Device

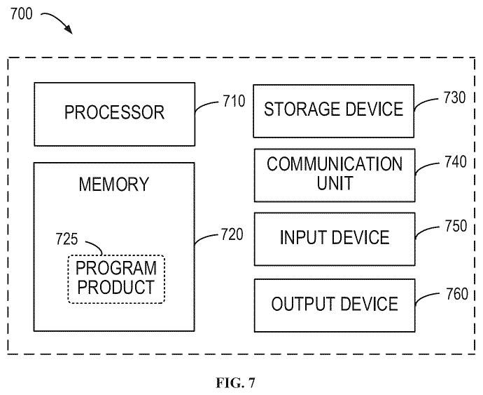

FIG. 6 shows a schematic structural block diagram of an apparatus 600 for application startup according to some embodiments of the disclosure. The apparatus 600 may be implemented as or included in the terminal device 110. Each module/component in the apparatus 600 may be implemented by hardware, software, firmware, or any combination thereof.

As shown in the figure, the apparatus 600 includes a determination module 610 configured to determine a plurality of file pages included in at least one file related to startup of an application and respective preloading types of the plurality of file pages; a loading module 620 configured to control, in response to detecting a first trigger event for the application, loading of the plurality of file pages from a disk to a plurality of linked lists in a memory, respectively, based on the respective preloading types of the plurality of file pages, where the plurality of linked lists respectively correspond to a plurality of file page reclaiming policies with respective priorities, and each preloading type is mapped to one of the plurality of linked lists; and an execution module 630 configured to perform a startup process of the application based on the plurality of file pages stored in the plurality of linked lists in the memory.

In some embodiments, the determination module 610 is further configured to determine the respective preloading types of the plurality of file pages based on a file type corresponding to each file page and historical startup data of the application, the historical startup data at least indicating a number of cache misses of each file page during a historical startup.

In some embodiments, the historical startup data further indicates at least one of a timestamp at which each of the plurality of file pages is read during startup, a file type, a number of cache misses, and a number of loads into the memory. The historical startup data is stored in association with an application identification of the application and a user identification of a user who launches the application.

In some embodiments, the historical startup data further indicates at least one of a file name, a file identification, an offset in a file, and a length of each file page.

In some embodiments, the determination module 610 is further configured to determine that a preloading type of a first file page is a first preloading type based on the number of cache misses of the first file page being less than or equal to a first threshold number, or based on the file type corresponding to the first file page being an application data type or a configuration file type; determine that a preloading type of a second file page is a second preloading type based on the number of cache misses of the second file page being less than or equal to a second threshold number, or based on the preloading type of the second file page being an executable file type; and determine that a preloading type of a third file page is a third preloading type based on the file type of the third file page being the third file page of a system file type.

In some embodiments, the determination module 610 is further configured to determine that the preloading type of the first file page is the second preloading type based on the file type corresponding to the first file page being the application data type or the configuration file type, but the number of cache misses of the first file page being greater than the first threshold number; and determine that the preloading type of the second file page is the third preloading type based on the preloading type of the second file page being the executable file type, but the number of cache misses of the second file page being greater than the second threshold number.

In some embodiments, the determination module 610 is further configured to acquire the historical startup data corresponding to the plurality of file pages loaded from an application cold start to first frame rendering of the application.

In some embodiments, the visual style determination module is further configured to determine a color value indicated by a visual style corresponding to a given content segment based on a pixel value of each pixel of the at least one reference frame.

In some embodiments, the loading module 620 is further configured to load the plurality of file pages into the plurality of linked lists based on an order of timestamps at which the plurality of file pages are read during a historical startup.

In some embodiments, the loading module 620 is further configured to load, in response to a preloading type of a first file page among the plurality of file pages being the first preloading type, the first file page into a first linked list of the plurality of linked lists, the first linked list having a first priority file page reclaiming policy; load, in response to a preloading type of a second file page among the plurality of file pages being the second preloading type, the second file page into a second linked list of the plurality of linked lists, the second linked list having a second priority file page reclaiming policy, the second priority being lower than the first priority; and load, in response to a preloading type of a third file page among the plurality of file pages being the third preloading type, the third file page into a third linked list of the plurality of linked lists, the third linked list having a third priority file page reclaiming policy, the third priority being lower than the second priority.

In some embodiments, the loading module 620 is further configured to lock, in response to a preloading type of a fourth file page among the plurality of file pages being the third preloading type and the number of cache misses of the fourth file page being greater than a third threshold number, the fourth file page in the memory using a memory locking mechanism to.

In some embodiments, the apparatus 600 further includes a detecting module configured to determine that the first trigger event is detected in response to determining a press event for the application based on a detected touch operation.

FIG. 7 shows a block diagram of an electronic device 700 in which one or more embodiments of the disclosure may be implemented. It would be appreciated that the electronic device 700 shown in FIG. 7 is only illustrative and should not constitute any limitation on the functionality and scope of the embodiments described herein. The electronic device 700 shown in FIG. 7 may be used to implement the terminal device 110 of FIG. 1A.

As shown in FIG. 7, the electronic device 700 is in the form of a general-purpose electronic device. The components of the electronic device 700 may include, but are not limited to, one or more processors or processing units 710, a memory 720, a storage device 730, one or more communication units 740, one or more input devices 750, and one or more output devices 760. The processor 710 may be an actual or virtual processor and may execute various processes based on the programs stored in the memory 720. In a multi-processor system, multiple processors execute computer-executable instructions in parallel to improve the parallel processing capability of the electronic device 700.

The electronic device 700 typically includes multiple computer storage medium. Such medium may be any available medium that is accessible to the electronic device 700, including, but not limited to, volatile and non-volatile medium, removable and non-removable medium. The memory 720 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine-readable medium such as a flash drive, a disk, or any other medium, which may be used to store information and/or data (such as training data for training) and may be accessed within the electronic device 700.

The electronic device 700 may further include additional removable/non-removable, volatile/non-volatile memory medium. Although not shown in FIG. 7, it is possible to provide a disk driver for reading from or writing to a removable, non-volatile disk (such as a “floppy disk”), and an optical disk driver for reading from or writing to a removable, non-volatile optical disk. In these cases, each driver may be connected to the bus (not shown) by one or more data medium interfaces. The memory 720 may include a computer program product 725, which has one or more program modules configured to perform various methods or acts of various embodiments of the disclosure.

The communication unit 740 implements communication with other electronic devices through a communication medium. Additionally, the functions of the components of the electronic device 700 may be implemented by a single computing cluster or multiple computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed, the external devices such as a storage device, a display device, etc., communicate with one or more devices that enable the user to interact with the electronic device 700, or communicate with any devices (e.g., a network card, a modem, etc.) that enable the electronic device 700 to communicate with one or more other electronic devices. Such communication may be performed via input/output (I/O) interfaces (not shown).

According to an illustrative implementation of the disclosure, there is provided a computer-readable storage medium having computer-executable instructions stored thereon, where the computer-executable instructions are executed by a processor to implement the method described above. According to an illustrative implementation of the disclosure, there is further provided a computer program product tangibly stored on a non-transitory computer-readable medium and including computer-executable instructions, the computer-executable instructions being executed by a processor to implement the method described above.

Various aspects of the disclosure are described herein with reference to the flowcharts and/or block diagrams of the method, the apparatus, the device, and the computer program product implemented according to the disclosure. It would be appreciated that each block of the flowcharts and/or block diagrams, and combinations of blocks in the flowcharts and/or block diagrams may be implemented by computer-readable program instructions.

These computer-readable program instructions may be provided to a processor of a general-purpose computer, a special-purpose computer, or other programmable data processing apparatus to produce a machine, such that the instructions, when executed by the processor of the computer or other programmable data processing apparatus, create an apparatus for implementing the functions/acts specified in one or more blocks of the flowcharts and/or block diagrams. These computer-readable program instructions may also be stored in a computer-readable storage medium, the instructions cause a computer, a programmable data processing apparatus, and/or other devices to operate in a particular manner, and thus the computer-readable medium storing the instructions includes an article of manufacture that includes instructions for implementing various aspects of the functions/acts specified in one or more blocks of the flowcharts and/or block diagrams.

The computer-readable program instructions may be loaded onto a computer, another programmable data processing apparatus, or other devices to cause a series of operation steps to be performed on the computer, the other programmable data processing apparatus, or the other devices, to produce a computer-implemented process, such that the instructions executed on the computer, the other programmable data processing apparatus, or the other devices implement the functions/acts specified in one or more blocks of the flowcharts and/or block diagrams.

The flowcharts and block diagrams in the drawings show the possibly implemented architectures, functions, and operations of the system, the method, and the computer program product according to multiple implementations of the disclosure. In this regard, each block in the flowchart or block diagram may represent a module, program segment, or part of an instruction, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It also needs to be noted that each block in the block diagrams and/or flowcharts, and the combination of the blocks in the block diagrams and/or flowcharts may be implemented by a special-purpose hardware-based system that perform specified functions or acts, or may be implemented by a combination of special-purpose hardware and computer instructions.

The implementations of the disclosure have been described above, and the above description is illustrative, non-exhaustive, and not intended to limit the disclosed implementations. Many modifications and variations will be apparent to those of ordinary skill in the art without departing from the scope and spirit of the described implementations. The terms used herein are chosen to best explain the principles of the implementations, the practical applications or improvements to the technologies in the market, or to enable other those of ordinary skill in the art to understand the implementations disclosed herein.

1. A method for application startup, comprising:
determining a plurality of file pages comprised in at least one file related to startup of an application and respective preloading types of the plurality of file pages;
controlling, in response to detecting a first trigger event for the application, loading of the plurality of file pages from a disk to a plurality of linked lists in a memory, respectively, based on the respective preloading types of the plurality of file pages, wherein the plurality of linked lists respectively correspond to a plurality of file page reclaiming policies with respective priorities, and each preloading type is mapped to one of the plurality of linked lists; and
performing a startup process of the application based on the plurality of file pages stored in the plurality of linked lists in the memory.

2. The method of claim 1, wherein determining the respective preloading types of the plurality of file pages comprises:
determining the respective preloading types of the plurality of file pages based on at least one of a file type corresponding to each file page and historical startup data of the application, the historical startup data at least indicating a number of cache misses of each file page during a historical startup.

3. The method of claim 2, wherein the historical startup data further indicates at least one of a timestamp at which each of the plurality of file pages is read during the startup, a number of cache misses, and a number of loads into the memory, wherein the historical startup data is stored in association with an application identification of the application and a user identification of a user who launches the application.

4. The method of claim 2, wherein the historical startup data further indicates at least one of a file name, a file identification, an offset in a file, and a length of each file page.

5. The method of claim 2, wherein determining the respective preloading types of the plurality of file pages comprises:
determining that a preloading type of a first file page is a first preloading type based on the number of cache misses of the first file page being less than or equal to a first threshold number, or based on the file type corresponding to the first file page being an application data type or a configuration file type;
determining that a preloading type of a second file page is a second preloading type based on the number of cache misses of the second file page being less than or equal to a second threshold number, or based on the preloading type of the second file page being an executable file type; and
determining that a preloading type of a third file page is a third preloading type based on the file type of the third file page being the third file page of a system file type.

6. The method of claim 5, further comprising:
determining that the preloading type of the first file page is the second preloading type based on the file type corresponding to the first file page being the application data type or the configuration file type, but the number of cache misses of the first file page being greater than the first threshold number; and
determining that the preloading type of the second file page is the third preloading type based on the preloading type of the second file page being the executable file type, but the number of cache misses of the second file page being greater than the second threshold number.

7. The method of claim 2, further comprising:
acquiring the historical startup data corresponding to the plurality of file pages loaded from a cold start of the application to first frame rendering of the application.

8. The method of claim 1, wherein the loading of the plurality of file pages into the plurality of linked lists in the memory comprises:
loading the plurality of file pages into the plurality of linked lists based on an order of timestamps at which the plurality of file pages are read during a historical startup.

9. The method of claim 1, wherein the loading of the plurality of file pages into the plurality of linked lists in the memory comprises:
loading, in response to a preloading type of a first file page among the plurality of file pages being a first preloading type, the first file page into a first linked list of the plurality of linked lists, the first linked list having a first priority file page reclaiming policy;
loading, in response to a preloading type of a second file page among the plurality of file pages being a second preloading type, the second file page into a second linked list of the plurality of linked lists, the second linked list having a second priority file page reclaiming policy, the second priority being lower than the first priority; and
loading, in response to a preloading type of a third file page among the plurality of file pages being a third preloading type, the third file page into a third linked list of the plurality of linked lists, the third linked list having a third priority file page reclaiming policy, the third priority being lower than the second priority.

10. The method of claim 1, wherein controlling the loading of the plurality of file pages from the disk to the plurality of linked lists in the memory based on the respective preloading types of the plurality of file pages further comprises:
locking a fourth file page in the memory using a memory locking mechanism in response to a preloading type of the fourth file page among the plurality of file pages being a third preloading type, and a number of cache misses of the fourth file page being greater than a third threshold number.

11. The method of claim 1, wherein detecting the first trigger event comprises:
determining that the first trigger event is detected in response to determining a press event for the application based on a detected touch operation.

12. An electronic device, comprising:
at least one processor; and
at least one memory coupled to the at least one processor and storing instructions executable by the at least one processor, the instructions, when executed by the at least one processor, causing the electronic device to perform operations comprising:
determining a plurality of file pages comprised in at least one file related to startup of an application and respective preloading types of the plurality of file pages;
controlling, in response to detecting a first trigger event for the application, loading of the plurality of file pages from a disk to a plurality of linked lists in a memory, respectively, based on the respective preloading types of the plurality of file pages, wherein the plurality of linked lists respectively correspond to a plurality of file page reclaiming policies with respective priorities, and each preloading type is mapped to one of the plurality of linked lists; and
performing a startup process of the application based on the plurality of file pages stored in the plurality of linked lists in the memory.

13. The electronic device of claim 12, wherein determining the respective preloading types of the plurality of file pages comprises:
determining the respective preloading types of the plurality of file pages based on at least one of a file type corresponding to each file page and historical startup data of the application, the historical startup data at least indicating a number of cache misses of each file page during a historical startup.

14. The electronic device of claim 13, wherein the historical startup data further indicates at least one of a timestamp at which each of the plurality of file pages is read during the startup, a number of cache misses, and a number of loads into the memory, wherein the historical startup data is stored in association with an application identification of the application and a user identification of a user who launches the application.

15. The electronic device of claim 13, wherein the historical startup data further indicates at least one of a file name, a file identification, an offset in a file, and a length of each file page.

16. The electronic device of claim 13, wherein determining the respective preloading types of the plurality of file pages comprises:
determining that a preloading type of a first file page is a first preloading type based on the number of cache misses of the first file page being less than or equal to a first threshold number, or based on the file type corresponding to the first file page being an application data type or a configuration file type;
determining that a preloading type of a second file page is a second preloading type based on the number of cache misses of the second file page being less than or equal to a second threshold number, or based on the preloading type of the second file page being an executable file type; and
determining that a preloading type of a third file page is a third preloading type based on the file type of the third file page being the third file page of a system file type.

17. The electronic device of claim 15, wherein the operations further comprise:
determining that the preloading type of the first file page is the second preloading type based on the file type corresponding to the first file page being the application data type or the configuration file type, but the number of cache misses of the first file page being greater than the first threshold number; and
determining that the preloading type of the second file page is the third preloading type based on the preloading type of the second file page being the executable file type, but the number of cache misses of the second file page being greater than the second threshold number.

18. The electronic device of claim 13, wherein the operations further comprise:
acquiring the historical startup data corresponding to the plurality of file pages loaded from a cold start of the application to first frame rendering of the application.

19. The electronic device of claim 12, wherein the loading of the plurality of file pages into the plurality of linked lists in the memory comprises:
loading the plurality of file pages into the plurality of linked lists based on an order of timestamps at which the plurality of file pages are read during a historical startup.

20. A non-transitory computer-readable storage medium having computer-executable instructions stored thereon, the computer-executable instructions being executable by a processor to perform operations comprising:
determining a plurality of file pages comprised in at least one file related to startup of an application and respective preloading types of the plurality of file pages;
controlling, in response to detecting a first trigger event for the application, loading of the plurality of file pages from a disk to a plurality of linked lists in a memory, respectively, based on the respective preloading types of the plurality of file pages, wherein the plurality of linked lists respectively correspond to a plurality of file page reclaiming policies with respective priorities, and each preloading type is mapped to one of the plurality of linked lists; and
performing a startup process of the application based on the plurality of file pages stored in the plurality of linked lists in the memory.
